(19) United States
(12) Patent Application Publication
(10) Pub. No.: US 2009/0065423 A1
(43) Pub. Date: Mar. 12, 2009

(54) Filter sak

(76) Inventor: Edward J. Hetrick, East Freedom, PA (US)

Correspondence Address: Dwight G. Diehl, 117 South Juliana Street, Bedford, PA, 15522, US

(21) Appl. No.: 11/900,021

(22) Filed: Sep. 10, 2007

(51) Int. Cl. B01D 24/28; B01D 27/00

(52) U.S. Cl. 210/282; 210/242.1; 210/499

(57) ABSTRACT

The present invention is a washing machine filter that is disposable and free floating in the washing machine. The filter of the present invention in the preferred embodiment is 2¼ inches by 2½ inches. The filter is comprised of a filtering material of the dimension described, which can be placed in the washing machine with the items to be washed. This free floating and disposable filter does not require attachment to any part of the washing machine and can be used in any type of machine whether front loading or top loading. The filter allows the water in the machine to pass through it thus removing any impurities in the water. Such impurities can include grease, dirt, or other items which would soil the clothing. An additional advantage of the present invention is the filtering material can also be comprised of or contain an odor eliminating filter.

### BACKGROUND OF THE INVENTION

The present invention relates to a washing machine filter and more particularly said filter being disposable and free floating within a washing machine. Said filter is designed to filter from the water impurities such as dirt, oil, grease, and other items that become dislodged from the clothing or other items being washed. The filter can also remove odors.

The closest prior art would appear to be a washing machine filter as disclosed in U.S. Pat. No. 5,989,418. However, the filter of the '418 patent is designed to be attached to the dehydrating drum of the washing machine and specifically used to filter fluff from the washing water. The instant invention has the advantage that it is capable of being used with any style or type of washing machine and does not require being attached to the dehydrating drum or any other part of the washing machine. Other significant advantages of the present invention are that it is designed such that it will trap and remove dirt, impurities, odors, oil, grease and other items dislodged from the items being washed.

The advantages of the present invention are that it is an inexpensive, disposable filter that is usable with any size, type or style of washing machine. The present filter is simply deposited in the washing machine and the water flows through the filter during both the washing and rinsing cycles with dirt and other impurities being trapped by the filter medium inside the filter. Once the filter has become used or full, one simply disposes of it and drops another into the washing machine with the next load.

### BRIEF DESCRIPTION OF DRAWINGS

FIG. 1 is a frontal view of the filter in an assembled state.

FIG. 2 is a cross section of the filter of the present invention.

FIG. 3 illustrated the present invention in an unfolded, unsealed condition.

FIG. 4 illustrated the present invention in finished form.

FIG. 5 illustrates an alternative finished product.

FIG. 6 illustrates a third embodiment of the present invention.

### DETAILED DESCRIPTION OF THE INVENTION

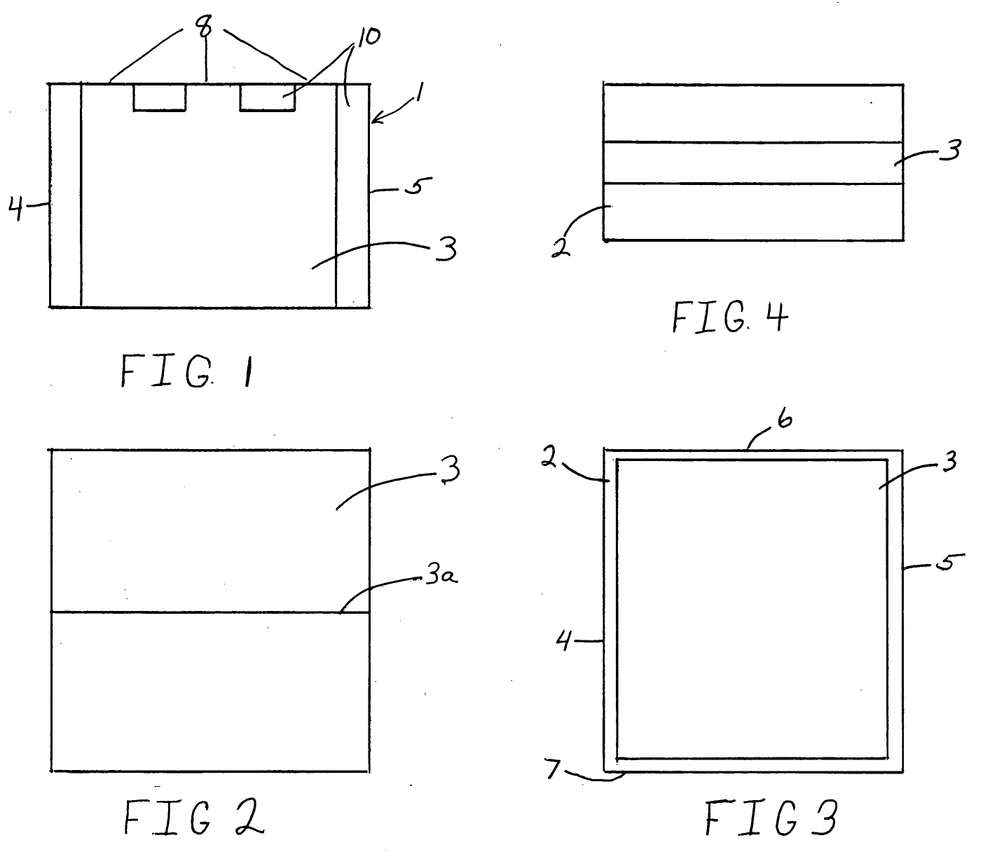

FIG. 1 and FIG. 2 show the preferred embodiment of the present invention. FIG. 1 shows the filter in its fully assembled and ready to use condition. The filter 1 as shown in FIG. 1, is comprised solely of the filter medium 3. As shown in FIG. 2, the filter medium is in an unassembled or open condition. To assemble the preferred embodiment one simply folds the filter medium 3, along the fold line 3a of the filter medium. Once the filter medium 3 is folded it is then secured together, in the preferred embodiment, by ultra sonic welding along side edges 4 and 5 and across the top edge 10 of the filter medium 3. The top edge 10 is also welded at a number of locations spaced a predetermined distance apart, thus allowing openings in the edge 10 for water and/or debris to enter into the filter medium 3 and be trapped therein. The openings 8, in the preferred embodiment, are three in number and located such that they are near the edges 4 and 5 and one in the center of the filter medium.

With this preferred embodiment the filter is comprised solely of one element, namely the filter medium 3 which is welded together along its edges 4 and 5 and partially welded along the edge 10 after having been folded along the fold line. The edge 10 comprises alternating openings and welded spaces across the face thereof.

As illustrated and described herein, the preferred embodiment has the filter medium ultrasonically welded together. However, as would be obvious and well known to one of ordinary skill in the art, the filter medium could be glued together or held together by some other means than welding and not depart from the inventive concept of the present invention.

FIG. 3 and FIG. 4 show a second embodiment of the present invention. FIG. 1 shows the filter in its fully assembled and ready to use condition. The filter 1 as shown in FIG. 3 with only the cover 2 visible has the preferred dimensions of 2¼ inches by 2½ inches. In this state the interior or inside of the cover 2 contains a filter medium 3, consisting of two layers in the preferred embodiment. To make the invention in this embodiment, a piece of cover 2, 4½ inches by 5 inches is laid flat, then on top of the cover 2 is placed a layer of filter medium 3, having the same dimensions or only slightly smaller dimensions than the cover 2. Once the filter medium 3 is placed on the cover 2, then both are folded in half such that the edges of the cover 2 are aligned and the edges of the medium 3 are aligned. Once in the folded condition, then the edges 4, 5, and 6 are welded together. The side edges 4 and 5 extend perpendicular from the fold 7 to the top edge 6 and are held together by ultra sonic welding. It should be noted that the use of ultra sonic welding of the cover material and filter medium 3 are the preferred method of producing the present invention. It should be noted however, that it is deemed to be obvious to one of ordinary skill in the art that the edges 4, 5, and 6 can be connected and sealed by a number of other means. Such other means could include gluing the edges together, utilizing thread and sewing the edges together, using a heat responsive cover material and melting the edges together; or placing Velcro strips on the edges 4, 5 and 6.

The present invention, once made by this method, or the preferred method, it is simply dropped into a washing machine and allowed to free float and move about therein. While the wash and rinse cycles of the machine take place, the water freely passes through the filter 1 thus causing dirt and other impurities in the water to be trapped by the filter medium 3. Once the wash and rinse cycles have been completed, the filter can be easily removed from the washing machine and discarded or if not full of impurities, then simply retained for use with the next load. It should be noted that the filter medium anticipated in the preferred embodiment consists of filtering mesh readily available on the market and, in and of itself, does not constitute a patentable element of the present invention. Alternative filtering medium 3 can also be charcoal or a charcoal filter utilized to remove odors. The charcoal or charcoal type filter can be used as the filter medium 3 alone, or in conjunction with the filter medium utilized to remove dirt and other impurities from the wash water. Also, the charcoal or odor absorbing material could be infused into the filter medium, thus allowing for the removal of odors as well as impurities.

Another advantage of the present invention, is that the filter medium 3, could be impregnated or infused with a cleaning material. The cleaning material could be a laundry detergent, a bleach, a degreaser or a fabric softener.

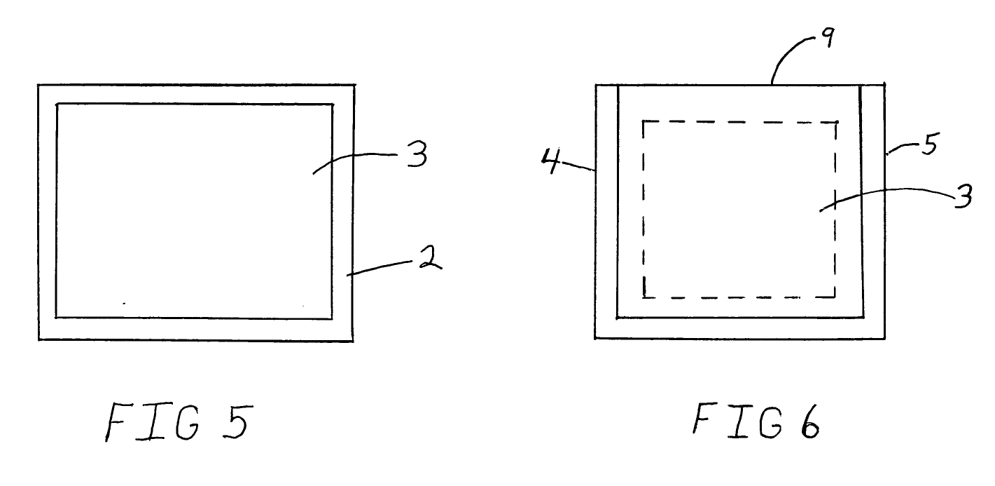

FIG. 5 illustrates a third embodiment of the present invention. In FIG. 5 the filter is constructed in a manner that utilizes two covers 2, and two layers of filter medium 3 sandwiched between the two cover layers 2. Once the four items are placed together they are then sealed along all four edges, either by ultra sonic welding, glue, Velcro, or melting, as recited above.

FIG. 6 involves a fourth embodiment of the present invention in which a piece of cover material 2 is utilized and sealed along the edges 4 and 5, again either with Velcro, glue, thread, or ultra sonic welding, thus forming a pouch with an end 9 remaining open through which the filter medium 3 can be installed. Once the filter medium 3 is placed inside the pouch formed by the cover material 2, the open end 9 is then sealed shut to prevent the filter medium from escaping. The filter medium can be of the filtering mesh type to filter impurities from the water and include charcoal or a charcoal filter, or it may be a charcoal type filter alone.

The above description details the preferred embodiment and manner of constructing the present invention as well as three alternative types of design. All four of the methods of construction do not hinder the performance of the present invention. The present invention is designed as an inexpensive, easy to use, disposable washing machine filter. The filter is designed to filter impurities such as dirt, grease, grime, or other solid material floating in the water that has been removed from the items being washed. In addition to, or in the alternative, an odor removing type of filter can be utilized. It is anticipated that charcoal or a charcoal filter could be placed inside the cover 2 and then deposited in the washing machine to remove odors from the items being washed.

The present invention has many advantages over the prior art. The present invention is inexpensive to manufacture and easy to use by the consumer. Further, it is completely versatile and usable with any type of washing machine, including top loading machines or front loading machines. Given the versatility of the present invention, it can be utilized with any type of washing machine and does not need to be attached to any portion thereof. Given the size and ease of use, the present invention could easily be taken with an individual while traveling and used at any laundry facility.

The present invention being a drop in, free floating filter and completely disposable, provides many advantages over the prior art filters utilized in washing machines. Also, the invention provides for reusability by securing the edges of the cover 2 with Velcro, thus allowing the consumer to remove a dirty filter medium 3 and place a clean, new filter medium inside the cover 2 and reseal.

While the present invention has been particularly shown and described with reference to particular embodiment thereof, it will be understood by those skilled in the art that various changes in form and details may be effected therein without departing from the spirit and scope of the invention as defined by the appended claims.

I claim:

1. A filter means for filtering impurities from water within a washing machine: said means comprising a disposable filter medium;
and said filter medium is free floating while in use.

2. The filter means as claimed in claim 1, wherein the filter medium is a mesh filter.

3. The filter means as claimed in claim 1, wherein the filter medium is contained within a filter cover.

4. The filter means as claimed in claim 3, wherein the filter medium is a charcoal filter.

5. Filter means as claimed in claim 3, wherein the filter medium is contained within the filter cover by means of ultra sonic welding on three sides and a hinge on a fourth side.

6. The filter means as claimed in claim 3, wherein the filter medium is contained within the filter cover by means of sealing four edges of the filter cover.

7. Filter means as claimed in claim 3, wherein the filter cover is reusable.

8. Filter means as claimed in claim 3, wherein the filter medium contains a cleaning material.
